(19) United States
(12) Patent Application Publication
(10) Pub. No.: US 2002/0099773 A1
(43) Pub. Date: Jul. 25, 2002

(54) Data communication apparatus and data communication method

(76) Inventor: Kaoru Tsuru, Tokyo (JP)

Correspondence Address: BIRCH STEWART KOLASCH & BIRCH, PO BOX 747, FALLS CHURCH, VA, 22040-0747, US

(21) Appl. No.: 09/916,515

(22) Filed: Jul. 30, 2001

(30) Foreign Application Priority Data
Jan. 25, 2001 (JP) 2001-016702

(51) Int. Cl. G06F 15/16; G06F 7/00

(52) U.S. Cl. 709/204; 707/3

(57) ABSTRACT

A data communication apparatus which allows a file to be shared among a plurality of personal computers (hereinafter referred to as “PC”) without using a file server, a Web server, or the like. According to the data communication apparatus, a inquiry executing section 6 on PC#1 (2) makes an inquiry to each of other PCs #2 to #n whether or not a file matching a specific keyword is stored in the shared files 30 stored in themselves. A search executing section 7 on each of the other PCs#2 to #n searches an index file 4 to search the file. The search executing section 7 returns a search result to PC#1. A search result receiving section 8 on PC#1 receives the search result. A file transmission requesting section 9 on PC#1 requests one of the other PCs to transmit a given file among files shown in search results received. A file receiving section 11 on PC#1 receives the given file transmitted from a file transmitting section 10 on the PC requested to transmit the given file.

### BACKGROUND OF THE INVENTION

1. Field of the Invention

The present invention relates to an information sharing technique to be used for sharing information among personal computers (referred to hereinafter as PCs), for example, which are connected over a network such as LAN or WAN. More particularly, the present invention relates to the information sharing technique that uses no server for centrally controlling files to be shared nor server for centrally controlling indexes.

2. Description of the Related Art

FIG. 14 shows the configuration of a system according to a first conventional example in which a file sever for providing file sharing services to PCs connected over a network.

FIG. 15 shows the configuration of a system according to a second conventional example in which two or more Web servers holding accessible files are connected over a network. The Web servers have hyper-links established therebetween to allow information to be shared among the users.

The operations of the conventional arts are now discussed.

According to the first conventional example, a network file control section on a PC issues a mount request to a network file service section on a file server based on a request from the user (a). Upon reception of the mount request, the network file service section grants a permission to the request, and then transmits various types of information to the network file control section, so that a disk holding shared files is treated as if the disk is the local disk of the PC (b). Consequently, the user is allowed to access the shared files in the same manner as to access the local disk.

According to the second conventional example, a browser on a PC issues an access request to a Web service section on a Web server based on a request from the user (a). The Web service section reads out a file for the access request from a disk (b), and then sends the file back to the browser (c). Then, the browser stores the file in a disk connected with the PC of the self (d), when required.

Problems posed by the conventional arts and to be solved by the present invention are discussed below.

According to first conventional example, there is a need of installing a file server to be used for providing a file sharing service to unspecified multiple users prior to an operation. Besides, there is a need of providing a setting for access right control separately on the individual PCs of the users for security.

According to the second conventional example, there is a need also of installing a Web server to be used for providing a file sharing service to unspecified multiple users prior to operation. Besides, there is a need of the user transferring a shared file generated by the user to a disk holding shared files on the Web server.

### SUMMARY OF THE INVENTION

The present invention is directed to solving the problems identified above.

These and other objects of the embodiments of the present invention are accomplished by the present invention as hereinafter described in further detail.

According to one aspect of the present invention, a data communication apparatus connected to at least more than one of data holding apparatuses, the data communication apparatus being allowed to use at least a part of data held by the data holding apparatuses as shared data, the data communication apparatus includes,

a search request generating and transmitting section for generating a search request which requests a data holding apparatus to search shared data corresponding to a given search condition from the shared data held by the data holding apparatus, and for transmitting the search request generated to the data holding apparatus,

a search result receiving section for receiving a search result for the search request from the data holding apparatus,

a data transmission request generating and transmitting section for generating a data transmission request which requests to transmit shared data searched based on the search result received by the search result receiving section, and for transmitting the data transmission request generated to the data holding apparatus, and

a data receiving section for receiving shared data requested to be transmitted by the data transmission request from the data holding apparatus to which the data transmission request is transmitted by the data transmission request generating and transmitting section.

According to another aspect of the present invention, a data communication apparatus, connected with at least more than one of data holding apparatuses, sharing with the data holding apparatuses at least a part of data which the data communication apparatus holds as shared data, the data communication apparatus includes,

a shared data storing section for storing data which the data communication apparatus holds as the shared data,

a search executing section for receiving a search request from a specific data holding apparatus, the search request requesting to search shared data corresponding to a given search condition from the shared data stored in the shared data storing section, for sharing the shared data corresponding to the search condition based on the search request received, and for transmitting a search result to the specific data holding apparatus,

a data transmission request receiving section for receiving from the specific data holding apparatus a data transmission request which requests to transmit shared data searched by the search executing section, and

a data transmitting section for transmitting shared data requested to be transmitted to the specific data holding apparatus based on the data transmission request received by the data transmission request receiving section.

According to still another aspect of the present invention, a data communication method for communicating with at least more than one of data holding apparatuses and for using at least a part of data held by the data holding apparatuses as shared data, the data communication method includes,

generating a search request which requests a data holding apparatus to search shared data corresponding to a given search condition from the shared data held by the data holding apparatus,

transmitting the search request generated to the data holding apparatus,

receiving search result for the search request from the data holding apparatus,

generating a data transmission request which requests to transmit shared data searched based on the search result received in the receiving the search result,

transmitting the data transmission request generated to the data holding apparatus, and

receiving shared data requested to be transmitted by the data transmission request from the data holding apparatus to which the data transmission request is transmitted in the transmitting the data transmission request.

According to still another aspect of the present invention, a data communication method for communicating with at least more than one of data holding apparatuses and for sharing with the data holding apparatuses at least a part of data which the data communication method holds as shared data, the data communication method includes,

storing data which the data communication method holds as the shared data,

receiving a search request from a specific data holding apparatus, the search request requesting to search shared data corresponding to a given search condition from the shared data stored in the storing,

searching the shared data corresponding to the search condition based on the search request received,

transmitting a search result to the specific data holding apparatus,

receiving a data transmission request which requests to transmit shared data searched in the searching, from the specific data holding apparatus, and

transmitting shared data requested to be transmitted to the specific data holding apparatus based on the data transmission request received in the receiving the data transmission request.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a block diagram showing a system configuration according to a first embodiment of the present invention;

FIG. 2 is a block diagram showing a system configuration according to a second embodiment of the present invention;

FIG. 3 is a flow chart illustrating the procedures of making an inquiry and receiving a search result according to a third embodiment of the present invention;

FIG. 4 is a block diagram showing a system configuration according to a fourth embodiment of the present invention;

FIG. 5 is a flow chart illustrating the procedures of generating an index according to a fifth embodiment of the present invention;

FIG. 6 is a flow chart illustrating the procedures of making an inquiry and receiving a search result according to a sixth embodiment of the present invention;

FIG. 7 is a block diagram showing a system configuration according to a seventh embodiment of the present invention;

FIG. 8 is a flow chart illustrating the procedures of making an inquiry according to an eighth embodiment of the present invention;

FIG. 9 is a flow chart illustrating the procedures of permitting the entrance of a new member PC according to a ninth embodiment of the present invention;

FIG. 10 is a block diagram of a system configuration according to a tenth embodiment of the present invention;

FIG. 11 is a block diagram showing a system configuration according to an eleventh embodiment of the present invention;

FIG. 12 is a block diagram showing a system configuration according to a twelfth embodiment of the present invention;

FIG. 13 is a block diagram showing a system configuration according to a thirteenth embodiment of the present invention;

FIG. 14 shows the configuration of a data communication system according to a first conventional example; and

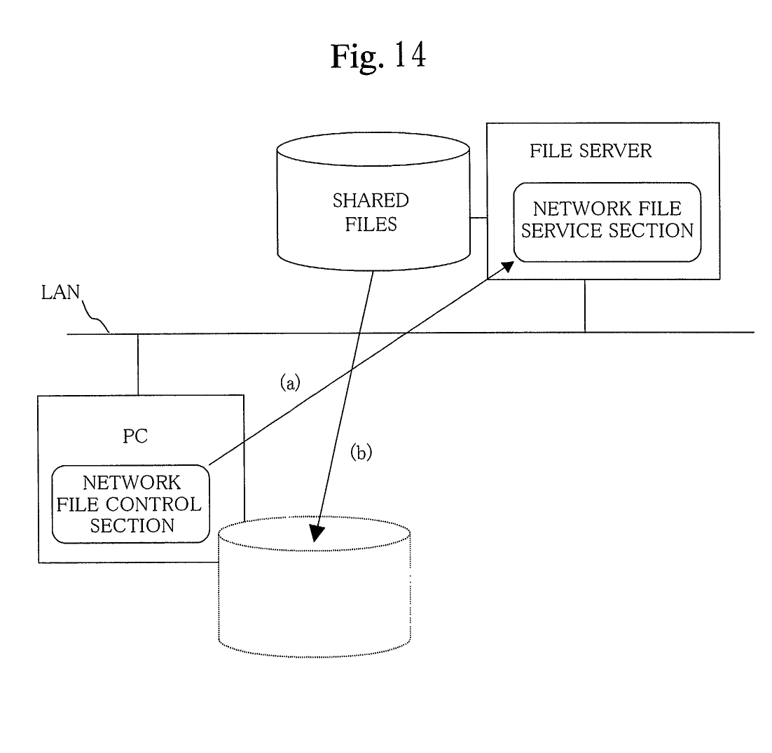

FIG. 15 shows the configuration of a data communication system according to a second conventional example.

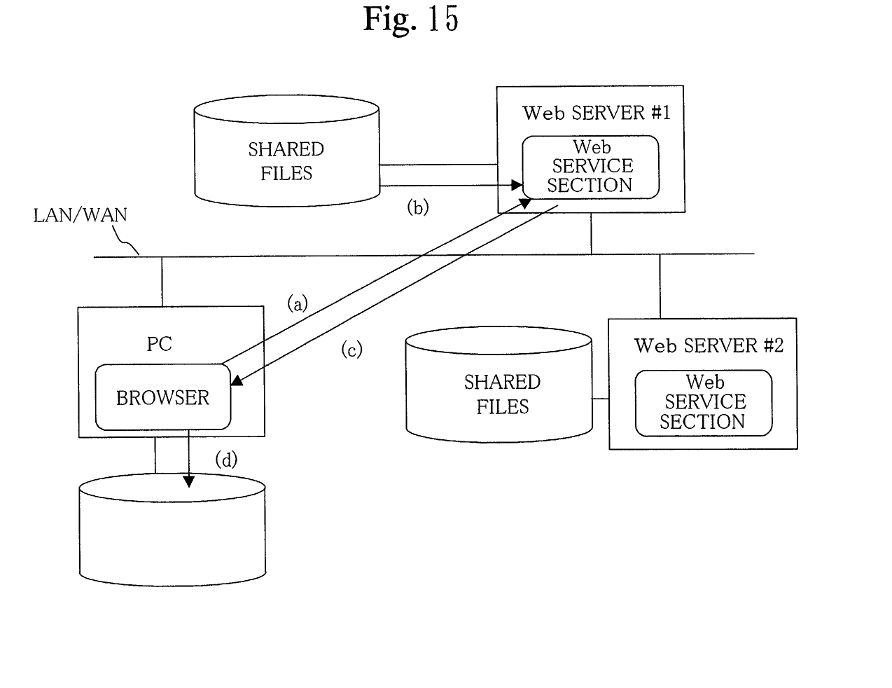

### DETAILED DESCRIPTION OF THE PREFERRED EMBODIMENTS

Reference will now be made in detail to the present preferred embodiments of the invention, examples of which are illustrated in the accompanying drawings, wherein like reference numerals indicate like elements through out the several views.

Embodiment 1.

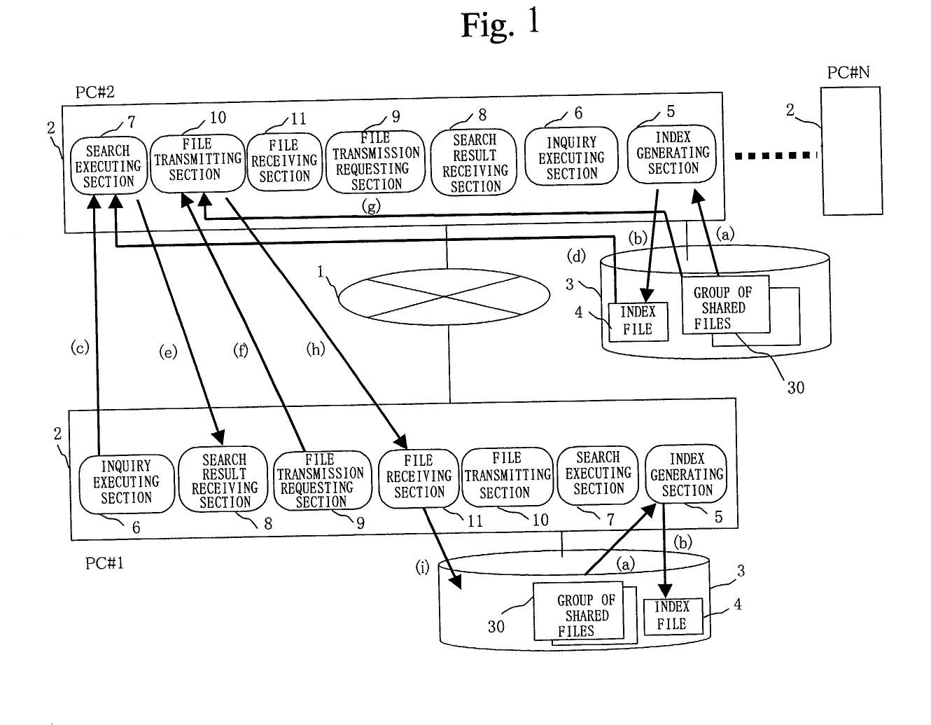

FIG. 1 is a block diagram illustrating a system configuration including a data communication apparatus and a data holding apparatus according to a first embodiment of the present invention.

Referring to FIG. 1, a reference numeral 1 denotes a network such as LAN or WAN. A reference numeral 2 denotes a PC connected over the network 1. The PC 2 serves as either a data communication apparatus or a data holding apparatus. A reference numeral 3 denotes a disk which is connected with the PC 2 and serves as a shared data storing section. The disk 3 holds shared files 30 inside as shared data.

The elements of the PC 2 are now elaborated. It is to be noted that all the PCs 2 connected over the network have their elements in common.

A reference numeral 4 denotes an index file of the shared files (shared data) 30 which is stored in the disk 3 connected with the PC 2. A reference numeral 5 denotes an index generating section.

A reference 6 denotes an inquiry executing section which generates an inquiry request (search request) to be sent to another PC 2 based on a request from the user, and transmits the inquiry request generated. The inquiry executing section 6 functions as a search request generating and transmitting section.

A reference numeral 7 denotes a search executing section which receives the inquiry request (search request) from another PC 2 and searches the index for the self PC based on the inquiry request received.

A reference numeral 8 denotes a search result receiving section which receives a search result from the search executing section 7 on another PC 2.

A reference numeral 9 denotes a file transmission requesting section which requests the transmission of a file specified by the user among files in the search result received by the search result receiving section 8. The file transmission requesting section functions as a data transmission request generating and transmitting section.

A reference numeral 10 denotes a file transmitting section which transmits a requested file in response to the file transmission request transmitted by the file transmission requesting section 9 on another PC. The file transmitting section functions as a data transmitting section.

A reference numeral 11 denotes a file receiving section which receives a file transmitted by the file transmitting section 10 on another PC, and stores the file in a disk. The file receiving section functions as a data receiving section.

In addition to those, the PC 2 is further provided with a file transmission request receiving section (data transmission request receiving section), which is not shown in FIG. 1, for receiving the file transmission request transmitted by the file transmission requesting section.

An operation of the data communication apparatus of this embodiment is now discussed with reference to FIG. 1, in the case that one of the PCs 2, PC#1, requests the other PCs 2, PC#2 to PC#n, to search a shared file and transmit the shared file.

Initially, prior to an operation, the index generating section 5, on each PC 2, PC#1 to PC#n, reads out the shared files 30 of the self PC (a), generates an index and stores the index in the index file 4(b).

Then, the inquiry executing section 6 on PC#1 generates an inquiry request (search request) to be sent respectively to the other PCs #2 to #n based on a keyword entered into PC#1 by the user of PC#1. The inquiry executing section 6 then broadcasts the inquiry request generated to the other PCs #2 to #n (c).

On the other PCs #2 to #n, the search executing section 7 receives the inquiry request from PC#1. The search executing section 7 searches the index file 4 on the self PC (d) based on the keyword included in the inquiry request received and then sends a search result back to PC#1 (e).

On PC#1, the search result receiving section 8 receives a search result from the search executing section 7 on each of the other PCs #2 to #n. The search result receiving section 8 provides the user with the search result received.

Then, the file transmission requesting section 9 on PC#1 generates the file transmission request for the file specified by the user. The file transmission requesting section 9 then transmits the file transmission request generated to more than one of the other PCs #2-#n (f). Referring to the figure, the file transmission request is transmitted to PC#2.

Then, the file transmission request receiving section (not shown in the figure) on PC#2 receives the file transmission request from PC#1. Then, the file transmitting section 10 on PC#2 reads out from the disk 3 a file corresponding to the file transmission request received by the file transmission request receiving section (g), and transmits the readout file to PC#1 (h).

The file receiving section 11 on PC#1 receives the file transmitted by the file transmitting section 10 on PC#2 and stores the file received in the disk 3 for the self PC (i).

It is a positive effect of the data communication apparatus of this embodiment that information is allowed to be shared with other unspecified multiple PCs without having any file servers by controlling the index of itself independently and providing information to other PCs in response to the requests by other PCs.

Embodiment 2.

According to the data communication apparatus discussed above in the first embodiment, an inquiry is made to an unspecified number of other PCs by broadcasting. A second embodiment of the present invention introduces a data communication apparatus in which information is shared by a specified number of other PCs.

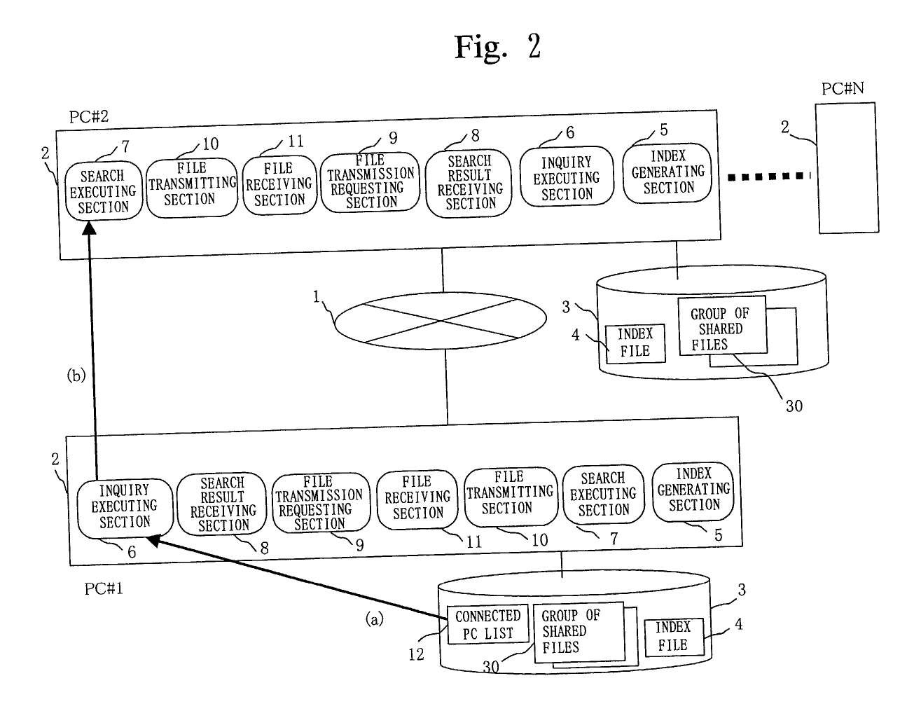

FIG. 2 shows a system configuration of the second embodiment.

Referring to the figure, reference numeral 1 to 11 and 30 denote the same elements as those having the same reference numerals discussed in the first embodiment. A reference numeral 12 denotes a connected PC list (search request transmitting destination information) including information about PCs which information is to be shared with.

For that reason, the disk 3 also functions as a search request transmitting destination information storing section in which the connected PC list (search request transmitting destination information) is stored according to this embodiment.

An operation of the data communication apparatus of this embodiment is now discussed.

Firstly, the basic operation of the data communication apparatus of this embodiment is the same as that of the data communication apparatus of the first embodiment, and therefore, descriptions will be made by focusing only on operations which differ from those of the data communication apparatus discussed in the first embodiment.

Prior to making an inquiry to the other PCs #2 to #n based upon a keyword entered by the user, the inquiry executing section 6 on PC#1 reads out the connected PC list 12 held by PC#1 of the self (a), and then multicasts an inquiry request only to the other PCs listed in the connected PC list 12(b).

It is to be noted that a series of operations following the transmission of the inquiry request by the inquiry executing section 6 of the data communication apparatus are the same as those of the data communication apparatus discussed in the first embodiment.

It is a positive effect of the data communication apparatus of this embodiment that the number of PCs with which to share information may be limited, thereby allowing the amount of communication for inquiry to be controlled, by providing the connected PC list prior to operation, especially in case of a sudden explosive increase occurs in an amount of communication for inquiry in a wide area network (internet) or an in-house network (intranet) over which a vast number of PCs are connected.

Embodiment 3.

According to the data communication apparatus discussed above in the second embodiment, a PC receives all the search results obtained from the other PCs listed in the connected PC list in response to the search request (inquiry request). A third embodiment of the present invention introduces a data communication apparatus in which upon reception of a specified number of search results, a PC terminates a series of operations for making an inquiry for search and receiving a search result.

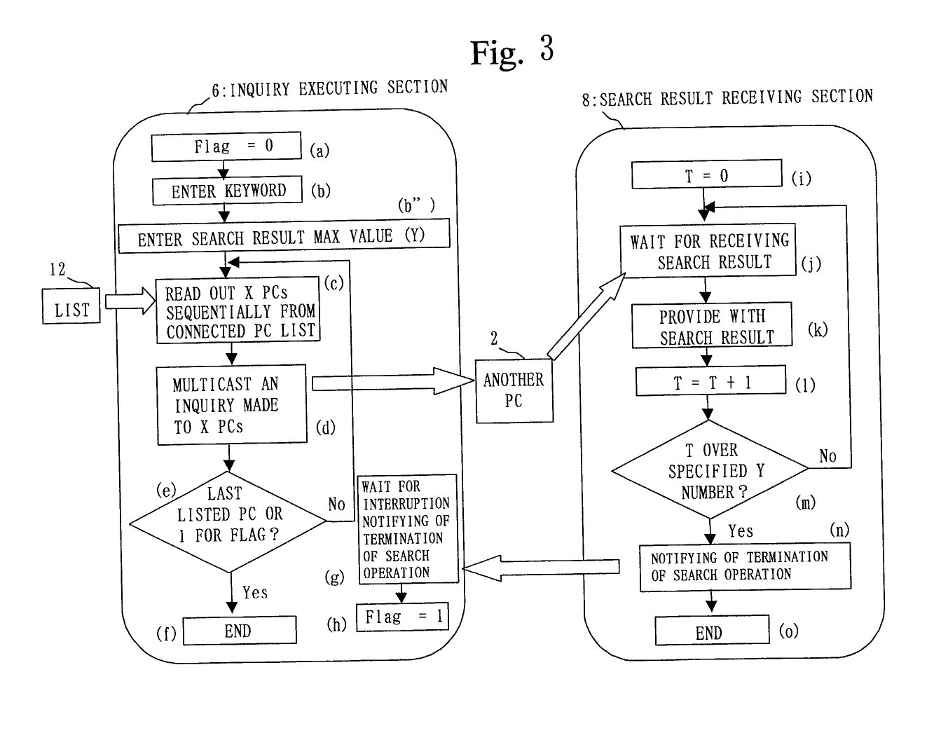

FIG. 3 is a flow chart illustrating such operations as mentioned above.

Referring to the figure, reference numerals denote the same elements as those having the same reference numerals discussed in the second embodiment.

An operation of the data communication apparatus of the third embodiment is now discussed. The basic operation of the data communication apparatus of this embodiment is same as that of the data communication apparatus of the second embodiment, and therefore, descriptions will be made by focusing only on operations which differ from those of the data communication apparatus discussed in the second embodiment with reference to the flow chart of FIG. 3.

Firstly, when activating the inquiry executing section 6, a flag is set to zero (0) in the inquiry executing section 6(a), then a keyword for search is entered by the user (b).

Then, a search result maximum value (Y) is entered by the user (b″). The search result maximum value (Y) is notified to the search result receiving section 8 from the inquiry executing section 6.

Then, the inquiry executing section 6 reads out PC information about a specified X number of PCs sequentially from the head of the connected PC list (c), and multicasts an inquiry to the specified X number of readout PCs (d).

Then, the inquiry executing section 6 examines if the connected PC list is read out through or not, or if the value of the flag is 1 or not (e). If the answer is yes to the step (e), then the operation is terminated (f). If the answer is no, then the operation proceeds back to repeat the operation in step (c). In the meantime, the inquiry executing section 6 waits for the notification of the termination of the search operation in an interruption wait routine (g). Upon reception of the notification, the inquiry executing section 6 sets the flag to 1 (h).

On the other hand, the search result receiving section 8 on PC#1 sets a primary variable T to zero (0) at the activation (i), waits for a search result from another PC (j). The search result receiving section 8, upon reception of a search result, provides the search result to the user (k), and adds 1 to the value of the primary variable T (1).

Then, the search result receiving section 8 examines whether or not the value of the primary variable T exceeds the specified Y number which is entered in step (b″) (m). If the answer is yes to the step (m), then the search result receiving section 8 interrupts to notify the inquiry executing section 6 of the termination of the search operation (n), and then terminates the operation (o). If the answer is no, then the operation proceeds back to repeat the operation in step (j).

It is a positive effect of the data communication apparatus of this embodiment that an amount of communication on the network may be controlled and the waiting time for search may be shortened by terminating the series of operations for transmitting an inquiry and receiving a search result upon reception of the specified number of search results.

Embodiment 4.

A fourth embodiment of the present invention introduces a data communication apparatus in which the waiting time for search may be shortened further than the waiting time discussed in the third embodiment.

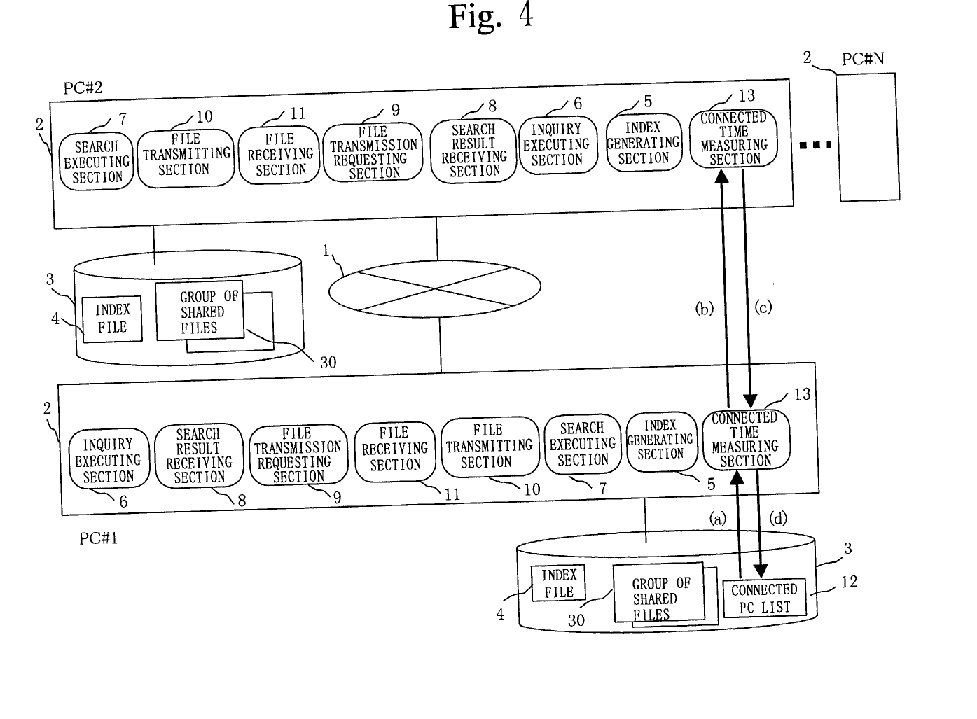

FIG. 4 shows a system configuration of the data communication apparatus according to the fourth embodiment.

Referring to the figure, the reference numerals 1 to 12 and 30 denote the same elements as those having the same reference numerals discussed in the second embodiment. A reference numeral 13 denotes a connected time measuring section for measuring a communicating time with another PC. The connected time measuring section 13 functions as a transmission order setting section.

An operation of the data communication apparatus of this embodiment is now discussed.

The basic operation of the data communication apparatus of this embodiment is the same as that discussed in the second embodiment, and therefore, descriptions will be made by focusing only on operations which differ from those of the data communication apparatus discussed in the second embodiment.

At user-specified time intervals asynchronously with the primary operation, the connected time measuring section 13 on PC#1 reads out the connected PC list held in PC#1 of the self (a), and transmits a connection confirmation request (test data) to each of the connected PCs separately in a list order (b).

The connected time measuring section 13 on another PC returns a response of confirmation spontaneously to the PC of transmitting the connection confirmation request upon reception of the connection confirmation request. The connected time measuring section 13 on PC#1, upon reception of the response, holds a communicating time between the transmission of the request and the reception of the response, and then transmits the connection confirmation request to the next PC in the list. The series of operations are repeated through all the PCs in the connected PC list 12. Then, the connected time measuring section 13 sorts the PCs in the connected PCs list 12 according to the communication time and re-arrange the order of PCs from shortest to longest, and stores the re-arranged list of connected PCs (d).

It is a positive effect of the data communication apparatus of this embodiment that the search time and the file transmitting/receiving time are allowed to be shorten particularly in a wide area network in which the network line condition is uncertain, by performing the sequential inquiry operation similar to that discussed in the third embodiment based on the connected PCs list sorted in the order of PCs having a shorter time for communication, and in other words, in the order of PCs having a less congested communication line.

Embodiment 5.

According to the data communication apparatus discussed in the first embodiment, the index is generated by the user instructing so. A fifth embodiment of the present invention introduces a data communication apparatus which examines regularly whether or not the files are updated or added. Based upon the detection of a file being updated or added, the index is re-generated.

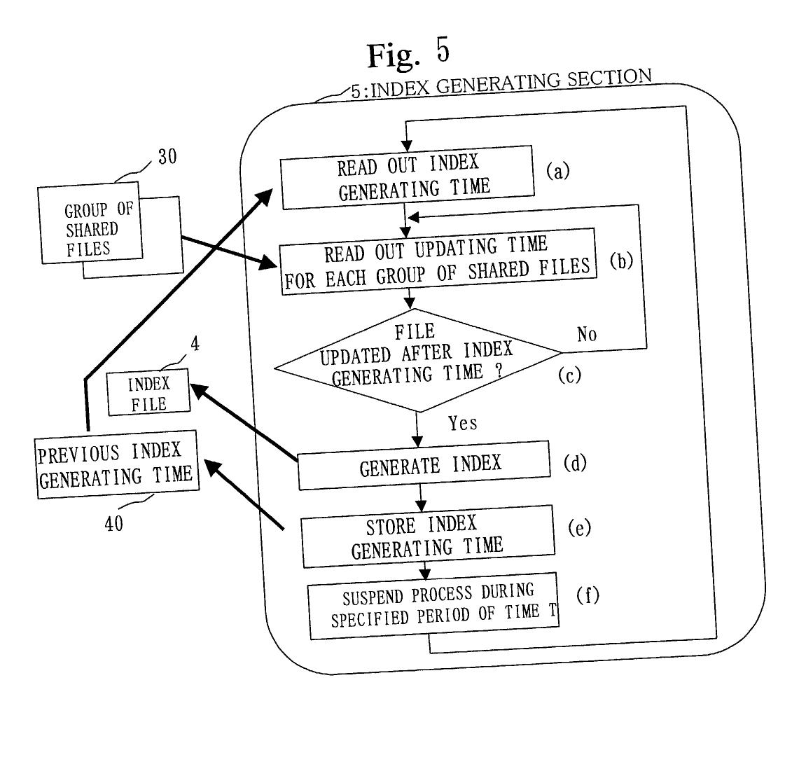

FIG. 5 is a flow chart illustrating an operation of the data communication apparatus of this embodiment.

The flow chart of FIG. 5 illustrates a series of internal operations of the index generating section 5.

An operation of the data communication apparatus of the fifth embodiment is now discussed.

Initially, the index generating section 5, when activated, reads out a previous index generating time 40 stored (a), and then reads out sequentially a file generating/updating time for each shared file in a directory storing shared files (b).

Then, it is examined that the file generating/updating time is after the previous index generating time 40 or not (c). If the answer is yes to the step (c), then the index generating section 5 generates an index, stores a generated index in the index file 4(d), and also stores the index generating time (e). Then, the index generating section 5 stops the operation during a specified interval T (f), and resumes the operation by proceeding back to step (a) after the specified interval T. If the answer is no to step (c), then the index generating section 5 reads out next file generating/updating time (b).

It is a positive effect of the data communication apparatus of this embodiment index that the number of generating indexes may be reduced, thereby decreasing the load on the PC for generating indexes by examining the file generating/updating time for each shared file to generate an.

Embodiment 6.

With reference to the first to third embodiments, a PC always makes an inquiry to another PC. A sixth embodiment of the present invention introduces a data communication apparatus which uses a past log to omit making the inquiry to another PC.

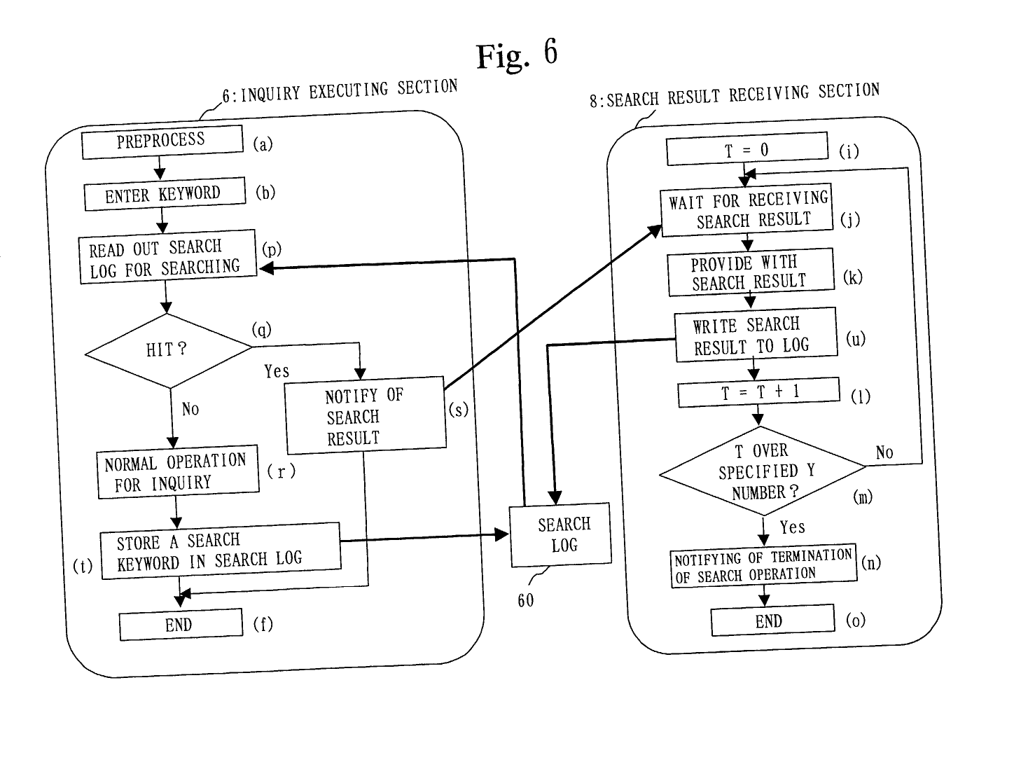

FIG. 6 is a flow chart illustrating an operation of the data communication apparatus of this embodiment.

The flow chart of FIG. 6 modifies the flow chart of FIG. 3 for the third embodiment by adding some alterations.

An operation of the data communication apparatus of this embodiment is now discussed.

The basic operation of the data communication apparatus of this embodiment is same as that of the data communication apparatus discussed in the third embodiment, and therefore, descriptions will be made by focusing only on operations which differ from those of the data communication apparatus discussed in the third embodiment.

The inquiry executing section 6, when activated, performs a pre-processing (a), receives a keyword entered by the user (b), reads out a search log stored in a search log storing section 60, and searches this search log based on the keyword (p). It is to be noted that the search log here is the history information of search requests. The search log stores a keyword, a search result in response to an inquiry request, the address of another PC from which the PC of the self received the search result, and so on for each inquiry request made previously in such a manner as to establish a correspondence among those. For that reason, the search log storing section 60 functions as a search request history information storing section.

Next, the inquiry executing section 6 compares an entered keyword with the keyword of each search log to examine whether or not those keywords match (q). If the answer is yes to the step (q), and in other words, the keywords match, then the inquiry executing section 6 obtains a search result from a corresponding search log and then informs the search result receiving section 8 of the search result obtained (s), which terminates the operation (f). If the answer is no, then the inquiry executing section 6 performs the normal operation for making an inquiry in the same manner as that discussed in the third embodiment (r), and stores the keyword for search in the search log storing section (t), which terminates the operation (f).

On the other hand, the search result receiving section 8 performs mostly in the same manner as those discussed in the third embodiment with an additional operation below. Upon reception of the notification of a past search result from the inquiry executing section 6, the search result receiving section 8 provides with the past search result to the user. Upon reception of no notification of a past search result from inquiry executing section 6, the search result receiving section 8 provides with a search result transmitted from another PC to the user (k). Thereafter, the search result receiving section 8 writes these search results to the search log storing section 60(u).

In this manner, the inquiry executing section 6 notifies the search result receiving section 8 of the past search result without transmitting an inquiry request to other PCs, if any log matches in a search operation of the search log. In other words, the search result receiving section 8 can obtain the search result from the inquiry executing section 6 without receiving a search result from another PC.

It is a positive effect of the data communication apparatus of this embodiment that the search time is allowed to be saved and the load for search on each of the other PCs may be decreased, in the case of frequently performing similar search operations, by performing a search operation based on the past search log.

Embodiment 7.

With reference to the second embodiment, it is required to have the connected PC list prior to operation for sharing information with other PCs. A seventh embodiment of the present invention introduces a data communication apparatus in which the connected PC list is dynamically generated/updated.

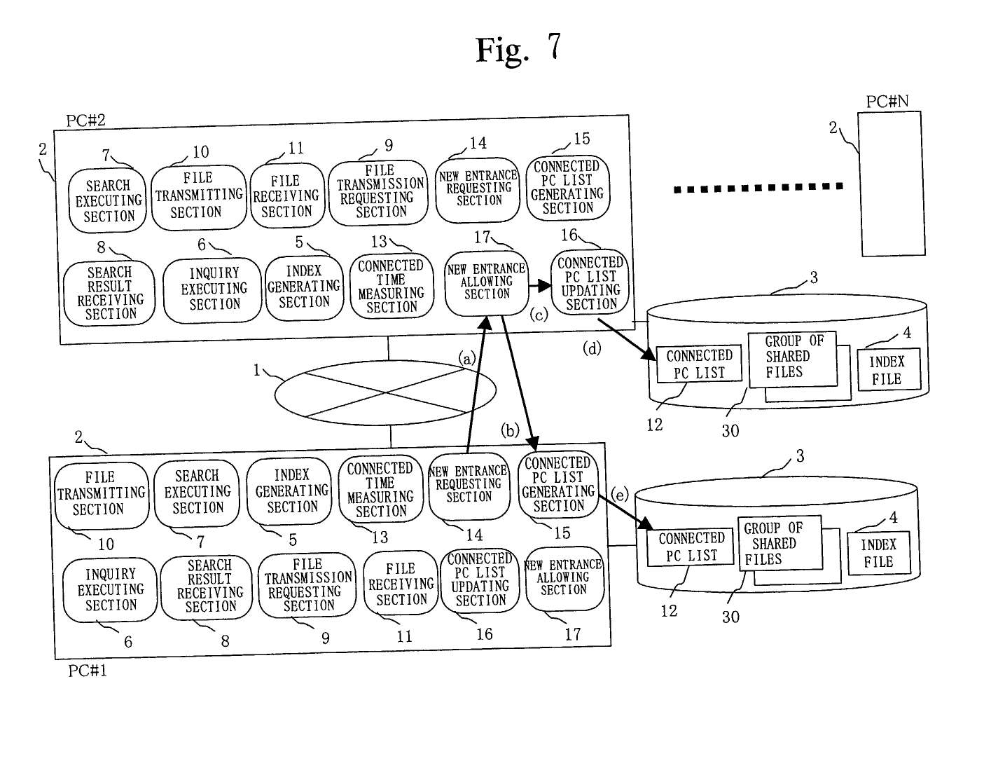

FIG. 7 shows a system configuration of the data communication apparatus according to the seventh embodiment of the present invention.

Referring to the figure, reference numerals 1 to 13 and 30 denote the same elements as those having the same reference numerals discussed in the previous embodiments.

A reference numeral 14 denotes a new entrance requesting section for issuing a new entrance request when starting to share information. A reference numeral 15 denotes a connected PC list generating section for generating a connected PC list based on information on another PC which responded with an allowance of the new PC for sharing information. A reference numeral 16 denotes a connected PC list updating section for adding a new member PC to the connected PC list of the self upon reception of the new entrance request from the new member PC. A reference numeral 17 denotes a new entrance allowing section for transmitting information of the self PC in response to the new entrance request from a new member PC. The new entrance requesting section 14 and the new entrance allowing section 17 each function as an identification information communicating section.

An operation of the data communication apparatus of this embodiment is now discussed with reference to FIG. 7 in the case that PC#1 is a new member PC trying to share files and the PCs #2 to #n are allowing PCs which allow the entrance of PC#1.

Firstly, on PC#1 not yet sharing information with others, the new entrance requesting section 14 broadcasts the new entrance request including the identification information of the self PC to the other PCs #2 to #n (a).

On the respective PCs #2 to #n, upon reception of the new entrance request, the new entrance allowing section 17 transmits the identification information of the self PC to PC#1 in response (b), and then transfers the identification information of the entering PC#1 to the connected PC list updating section 16(c). The connected PC list updating section 16 adds the identification information of the entering PC#1 to the connected PC list stored in the self PC (d).

On the other hand, the new entrance requesting section 14 on PC#1, upon reception of the identification information from the new entrance allowing section 17 of each of the other PCs #2 to #n, transfers the identification information received to the connected PC list generating section 15. The connected PC list generating section 15 generates a connected PC list 12 based on the identification information of each of the other PCs (e).

It is a positive effect of the data communication apparatus of this embodiment that the user is not needed to decide which PCs share information with each other by generating/updating dynamically the connected PC list for sharing information with one another among PCs.

Embodiment 8.

With reference to the second embodiment, a single list is provided as the connected PC list. An eighth embodiment of the present invention introduces a data communication apparatus which is provided with a plurality of connected PC lists.

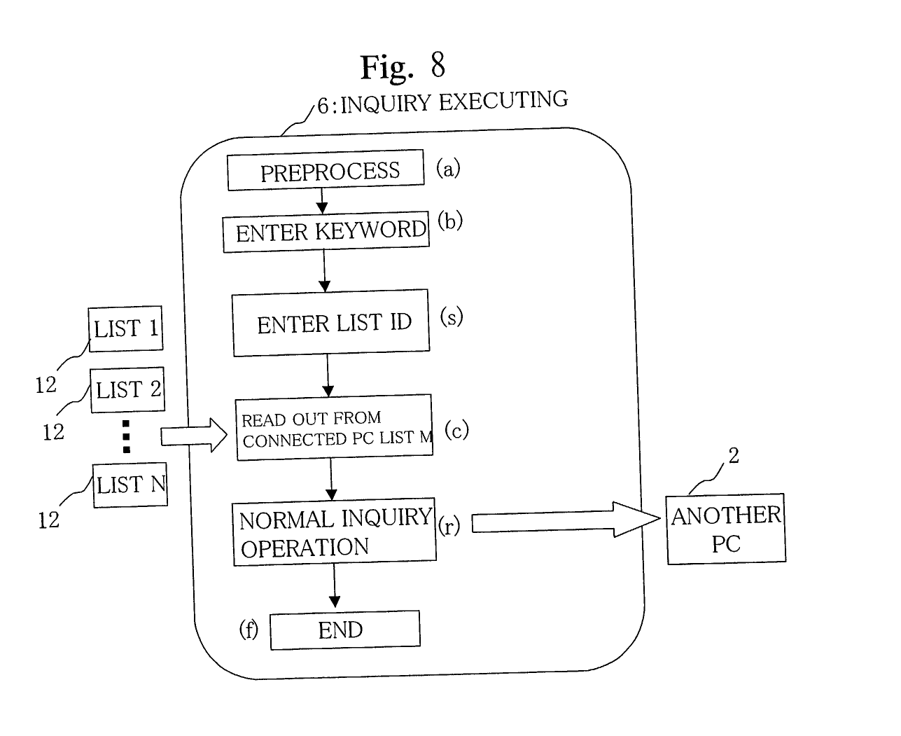

FIG. 8 is a flow chart illustrating an operation of the data communication apparatus of this embodiment.

Referring to the flow chart, the basic flow of operation of the inquiry executing section 6 is the same as that discussed in the previous embodiments.

An operation of the data communication apparatus of this embodiment is now discussed.

First, the inquiry executing section 6, when activated, performs pre-processing (a). Then, the inquiry executing section 6 receives a keyword for search from the user (b). Next, the inquiry executing section 6 receives from the user an identifier identifying one of the plurality of connected PC lists (s). Then, the inquiry executing section 6 reads out PCs from a corresponding connected PC list to a received identifier M (c). Subsequently, the inquiry executing section 6 performs the same series of operations for inquiry as those discussed in the previous embodiments (r), which terminates the whole course of operations (f).

It is a positive effect of the data communication apparatus of this embodiment thus having a plurality of connected PC lists for sharing information that information may be shared efficiently by classifying PCs in different lists by the type of information to be shared, for example.

Embodiment 9.

With reference to the seventh embodiment, a new member PC issuing the new entrance request is allowed to share information without any restriction from other PCs. A ninth embodiment of the present invention introduces a data communication apparatus in which the new entrance is allowed by a judgement by the user.

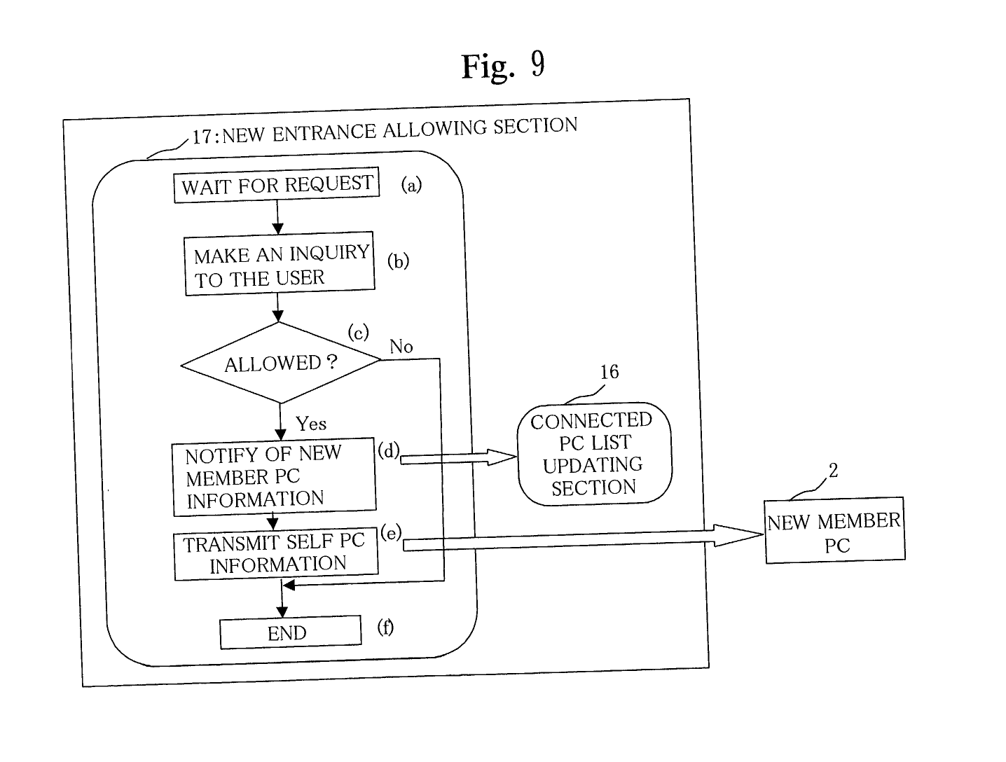

FIG. 9 is a flow chart illustrating an operation of the data communication apparatus of this embodiment.

An operation of the data communication apparatus of this embodiment is now discussed.

First, the new entrance allowing section 17, when activated, goes into a wait state for a new entrance request from a new PC (a). Upon reception of a new entrance request, the new entrance allowing section 17 provides the user with information on the new member PC and makes an inquiry whether or not the new entrance is allowed (b). Then, the new entrance allowing section 17 examines whether or not the new entrance is allowed by the user (c). When the answer is yes to the step (c), then the new entrance allowing section 17 notifies the connected PC list updating section 16 of the identification information on the new member PC (d), transmits the identification information of the self PC to the new member PC in response (e), and which terminates a whole course of operations (f). When the answer is no to the step (c), then the new entrance allowing section 17 notifies the new member PC of a rejected result of the new entrance in response (not shown in the flow chart).

It is a positive effect of the data communication apparatus of this embodiment that the number of PCs for sharing information may be controlled appropriately by allowing the user to decide whether or not to share information with another PC.

Embodiment 10.

With reference to the eighth embodiment, the PCs which information is to be shared with are divided into groups by identifier but the shared files are stored in a single group. A tenth embodiment of the present invention introduces a data communication apparatus in which the shared files are also divided into two or more groups.

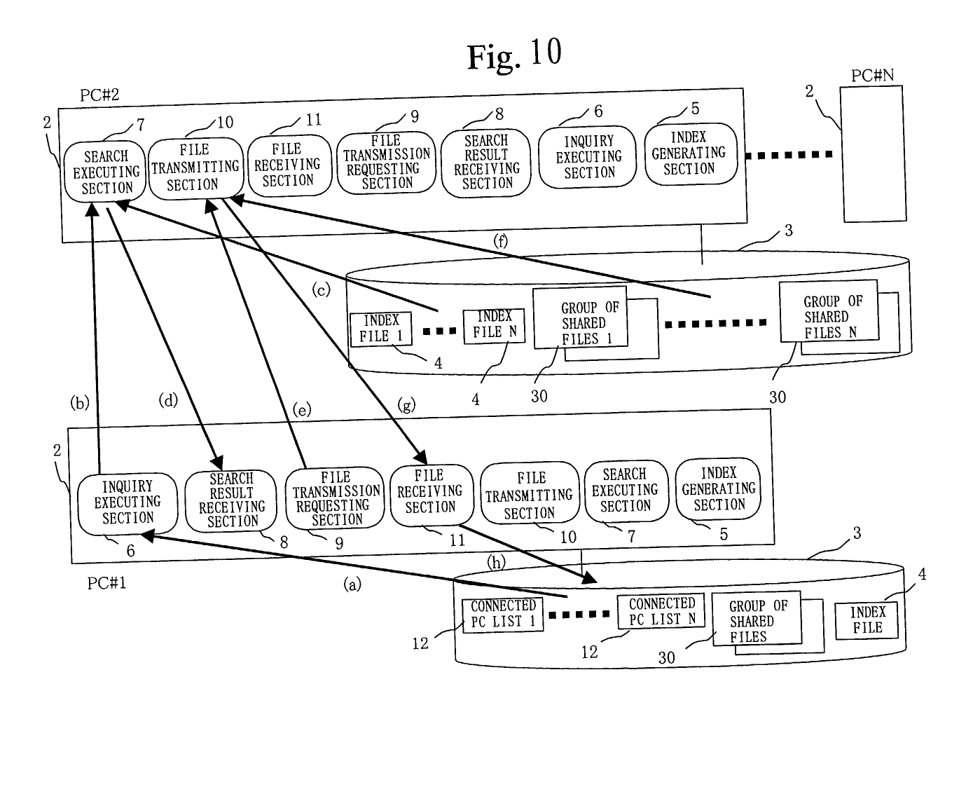

FIG. 10 shows a system configuration of the tenth embodiment.

According to this embodiment, each PC 2 is provided with a plurality of connected PC lists 12, a plurality of index files 4, and a plurality of groups of shared files 30. Referring to FIG. 10, PC#1 appears to be provided with only the connected PC lists 12 in a multiple manner, whereas PC#2 appears to be provided with only the index files 4 and the groups of shared files 30 in a multiple manner, which is for the sake of structural convenience of the figure. In fact, each PC 2 is provided with two or more connected PC lists 12, two or more index files 4 and two or more groups of shared files 30, and thus all in a plurality form.

The plurality of connected PC lists 12 is provided with identifiers being set to the individual connected PC lists 12. The plurality of index files 4 and the plurality of groups of shared files 30 are respectively provided with identifiers corresponding to those being set for the plurality of connected PC lists 12.

Besides, it is to be noted that the network 1 is omitted from FIG. 10 for the sake of structural convenience of the figure but, in fact, the PCs 2 are connected with each other over the network 1.

An operation of the data communication apparatus of this embodiment is now discussed.

In compliance with the operational flow of the inquiry executing section discussed in the eighth embodiment, the inquiry executing section 6 reads out one of the connected PC lists 12 having an identifier specified by the user (a), and makes an inquiry to PC#2 and/or other PCs based on the readout connected PC list 12 (b). It is to be noted that the inquiry request to be transmitted to PC#2 and/or other PCs includes an identifier specified by the user.

Then, the search executing section 7, on the PC upon reception of the inquiry request, searches the index file 4 corresponding to the identifier included in the inquiry request (c), and transmits a search result in response (d).

Subsequently, on PC#1, upon reception of the search result from the one or more of the PCs, the file transmission requesting section 9 issues a file transmission request of a file specified by the user (e). It is to be noted that the file transmission request also includes an identifier corresponding to the identifier of a connected PC list specified by the user.

Then, the file transmitting section 10 on PC#2 and/or other PCs, upon reception of the file transmission request, reads out a shared file corresponding to the identifier included in the file transmission request (f), and transmits the readout shared file (g).

The file receiving section 11 on PC#1, upon reception of the shared file from another PC, stores the file received in the disk (g).

It is a positive effect of the data communication apparatus of this embodiment that a search performance may be improved by dividing the shared files and the indexes into groups according to the type of shared information.

Embodiment 11.

An eleventh embodiment of the present invention introduces a data communication apparatus in which a file obtained as a result of a search operation is updated automatically.

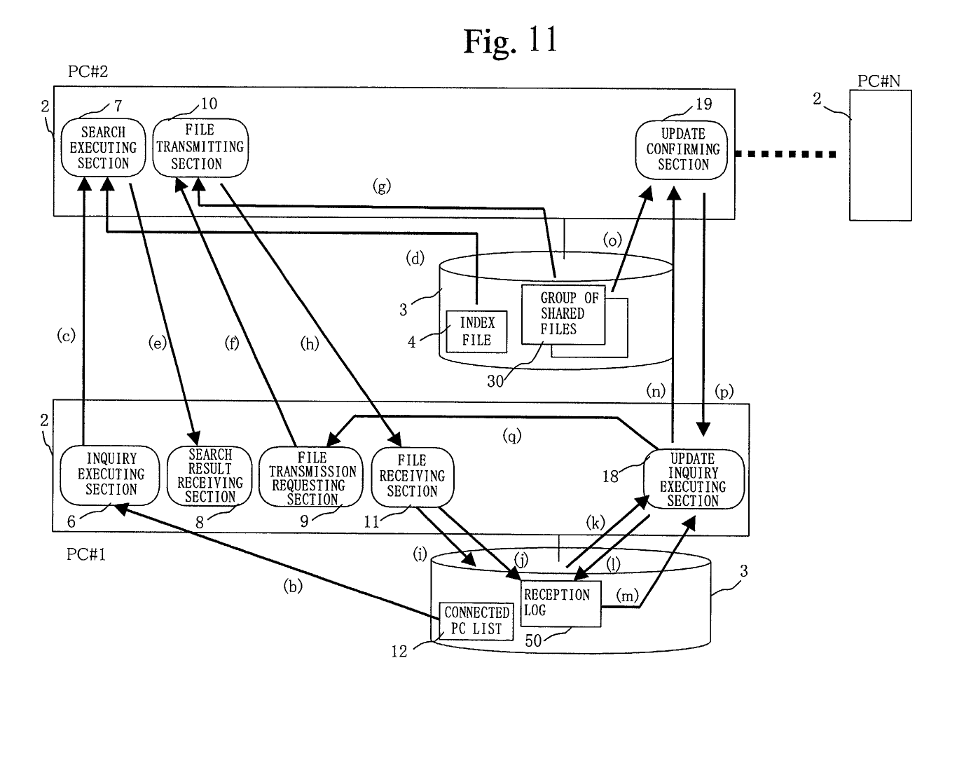

FIG. 11 shows a system configuration of the eleventh embodiment.

Reference numerals 1 to 12 and 30 denote the same elements as those having the same reference numerals discussed in the previous embodiments.

A reference numeral 18 denotes an update inquiry executing section (update confirmation requesting section) which issues an update confirmation request for requesting another PC to confirm whether or not a previously obtained file has been updated, and transmits the update confirmation request issued to the PC.

A reference numeral 19 denotes an update confirming section which receives the update confirmation request transmitted from another PC, confirms the updating time of a file in the self PC, and responds to the another PC about the file being updated or not.

A reference numeral 50 denotes a reception log.

The network 1 is not shown in FIG. 11 for the structural convenience of the figure. In fact, however, the PCs 2 are connected with one another over the network 1.

An operation of the data communication apparatus of this embodiment is now discussed.

The inquiry executing section 6 on PC#1 reads out the connected PC list 12 based on a keyword entered by the user (b), and broadcasts an inquiry request to other PCs (c). The search executing section 7 on another PC, upon reception of the inquiry request from PC#1, searches the index file 4 in the self PC (d), and returns a search result (e).

The search result receiving section 8 on PC#1, upon reception of the search result, provides the user with the search result.

The file transmission requesting section 9 on PC#1 issues a file transmission request of a file specified by the user (f). The file transmitting section 10 on another PC, upon reception of the file transmission request from PC#1, reads out the file from the disk 3(g), and transmits the file to PC#1 (h).

The file receiving section 11 on PC#1, upon reception of the file transmitted, stores the file in the disk 3 of the self PC (i), and also stores the name of the file received, information about the PC from which the file is transmitted, and the receiving time of the file into the reception log 50.

On the other hand, the update inquiry executing section 18 on PC#1 reads out the reception log 50(k), provides the user with a list of files, and writes back file information on a file which is specified to be updated automatically by the user in the reception log 50 (1).

Besides, as a periodically performed operation, the update inquiry executing section 18 reads out regularly file information on the file specified to be updated automatically from the reception log 50(m), and makes an inquiry to the PC from which the file is obtained whether or not the file has been updated since the file is obtained (n). The update confirming section 19 on another PC, upon reception of the inquiry, reads out the updating time of the file inquired (o), and responds to the update inquiry executing section 18 on PC#1 that the file has been updated or not (p).

The update inquiry executing section 18 on PC#1, upon reception of the response, in the case that the file has been updated, notifies the file transmission requesting section 9 to issue a file transmission request of the file (q). The file transmission requesting section 9 then issues the file transmission request to the PC responding that the file has been updated (f).

Subsequent operations will be performed in the same manner as the normal operations for inquiry discussed in the previous embodiments.

It is a positive effect of the data communication apparatus of this embodiment that shared information is allowed to be kept updated by the operation of updating an obtained file automatically.

Embodiment 12.

A twelfth embodiment of the present invention introduces a data communication apparatus in which the connected PC list are updated by analyzing a past reception log.

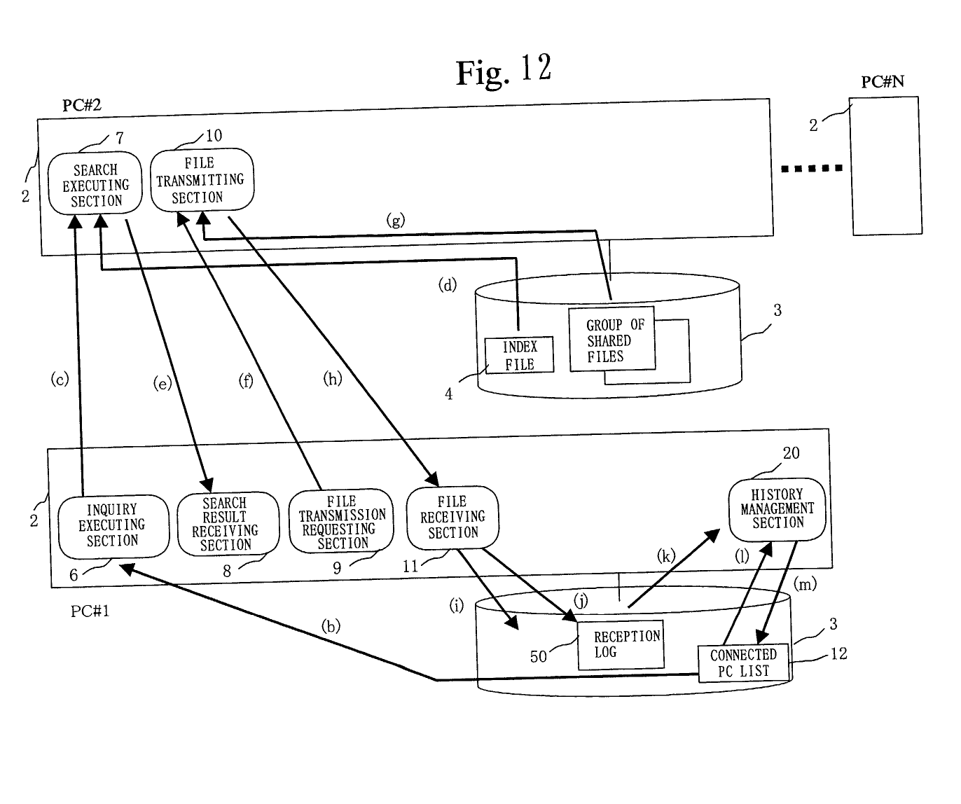

FIG. 12 shows a system configuration of the twelfth embodiment.

Reference numerals 1 to 12, 30 and 50 denotes the same elements as those having the same reference numerals discussed in the previous embodiments. A reference numeral 20 denotes a history management section for analyzing the past reception log to update the connected PC list. The history management section 20 functions as a data reception number counting section.

An operation of the data communication apparatus of this twelfth embodiment is now discussed.

The normal inquiry operations are performed in the same manner as those discussed in the eleventh embodiment.

On the other hand, the history management section 20 is activated regularly. The history management section 20 reads out the reception log 50(k), and counts the number of receiving files for each PC as the file transmitting PC.

Then, the history management section 20 reads out the connected PC list 12(l), and re-arranges PC information in the connected PC list according to the counted number of receiving files from most to least, and stores the connected PC list re-arranged (m).

It is a positive effect of the data communication apparatus of this embodiment that the search result may be more likely obtained earlier in response to the search inquiry by analyzing the reception log and re-arranging PC information in the connected PC list according to the number of receiving files from most to least.

Embodiment 13.

A thirteenth embodiment of the present invention introduces a data communication apparatus in which a file obtained as a result of a search operation from another PC is added to a group of shared files 30.

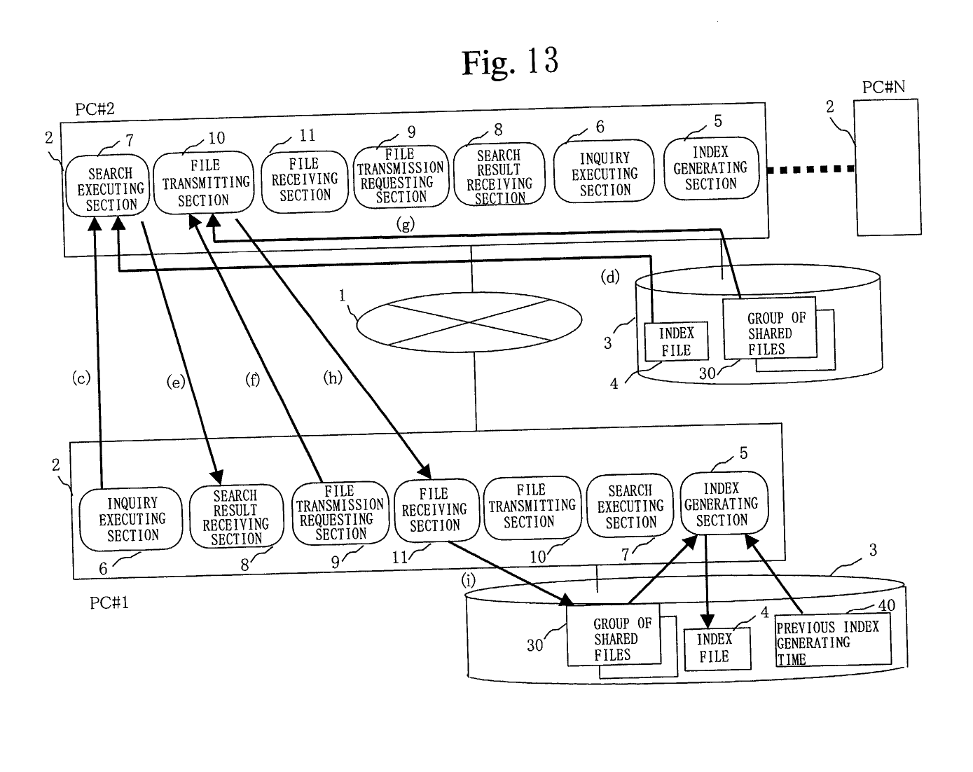

FIG. 13 shows a system configuration of the thirteenth embodiment.

The elements of the figure are the same as those having the same reference numerals discussed in the previous embodiments.

An operation of the data communication apparatus of this embodiment is now discussed.

A series of operations from executing an inquiry by the inquiry executing section 6(c) to receiving a file by the file receiving section 11(h) are same as those discussed in the first embodiment. Then, the file receiving section 11, upon reception of a file, adds the file received to a group of shared files 30(i).

The index generating section 5 examines regularly whether or not the files are generated/updated to regenerate the index file 4 in the same manner as that discussed in the fifth embodiment.

It is a positive effect of the data communication apparatus of this embodiment that by adding a searched file to a group of shared files in the self PC, highly accessible information is allowed to be stored in more PCs, thereby improving a search efficiency.

Alternatively, although the previous descriptions were directed to the data communication apparatus (personal computer) of the present invention. A data communication method of the present invention may be implemented through the same procedures discussed above.

Furthermore, although the personal computer has been discussed as an example of the data communication apparatus of the present invention, the data communication apparatus of the present invention may not be limited to the personal computer alone. The data communication apparatus of the present invention may be applicable to any apparatus or device that allows a file to be shared among one or more apparatuses or devices.

The following is a summary of the characteristics of the present invention discussed above.

The inter-computer information sharing system of the present invention, in a group of personal computers (referred to hereinafter as “PC”) which are connected with each other over the network and respectively hold files to be shared with a plurality of PCs, may be characterized with including the index generating section, the inquiry executing section, the search executing section, the search request receiving section, the file transmission requesting section, the file transmitting section and the file receiving section. The index generating section, generates regularly the index of the files to be shared. The inquiry executing section makes a search inquiry to all the other PCs in the group by broadcasting based on a keyword in a search request from the user. The search executing section searches the index in the self PC in response to an inquiry from another PC and returns a search result. The search result receiving section receives the search result from another PC and provides the user with the search result. The file transmission requesting section requests to transmit a file specified by the user based on the provided search result. The file transmitting section transmits a corresponding file in response to the file transmission request from another PC. The file receiving section receives a file transmitted.

Furthermore, the inter-computer information sharing system of the present invention may be characterized with including the connected PC list which lists information such as the addresses of PCs which information is shared with. Besides, the inter-computer information sharing system may be characterized further with the inquiry executing section making the search inquiry to other PCs by referring to the connected PC list in such a manner as to make the search inquiry only to the addresses listed in the connected PC list.

Still further, the inter-computer information sharing system of the present invention may be characterized with including the inquiry executing section which makes a search inquiry not by broadcasting but by making the search inquiry in a sequential manner to a predetermined number of the other PCs at a time. In addition to that, the inter-computer information sharing system of the present invention may be characterized further with having the search result receiving section which notifies the inquiry executing section, upon reception of the predetermined number of search results, that the operation for making an inquiry is to be stopped.

Still further, the inter-computer information sharing system of the present invention may be characterized with including the connected time measuring section which transmits the confirmation inquiry of an operation to other PCs based on addresses listed in the connected PC list, measures the time between the transmission of the confirmation inquiry and the reception of a response, and re-arranges information such as addresses listed in the connected PC list based on the measured result.

Still further, the inter-computer information sharing system of the present invention may be characterized with including the index generating section which examines regularly a directory having a group of shared files stored, and re-generates the index in the case of detecting a file generated later than the preciously examined time in the directory.

Still further, the inter-computer information sharing system of the present invention may be characterized with including the inquiry executing section which stores a search inquiry requested by the user and a search result from another PC as the search log, searches the search log first based on a new search request from the user, and when detecting a corresponding search result in the search log, then makes no inquiry to other PCs.

Still further, the inter-computer information sharing system of the present invention may be characterized with including the new entrance requesting section which broadcasts a notice to the respective PCs connected over the network that the PC joins to share information. In addition to that, the inter-computer information sharing system may be characterized with further including the connected PC list updating section which adds information such as the address of the PC of requesting new entrance in the connected PC list when receiving the new entrance request for sharing information. Still in addition to that, the inter-computer information sharing system may be characterized with further including the new entrance allowing section which transmits the notification that the new entrance for sharing information is accepted and information such as the address of the PC of its own to the PC of requesting new entrance. Still in addition to that, the inter-computer information sharing system may be characterized with further including the connected PC list generating section which receives the notification that the new entrance for sharing information is accepted and so forth and generates the connected PC list for the self PC.

Still further, the inter-computer information sharing system of the present invention may be characterized with including the inquiry executing section which controls a plurality of connected PC lists by adding identification information to each of the connected PC lists, and requests the user to provide with information specifying one of the connected PC lists when making a search request to other PCs based on a request from the user.

Still further, the inter-computer information sharing system of the present invention may be characterized with including the connected PC list updating section which adds information such as the address of the PC of a requesting end to the connected PC list after making an inquiry to the user whether or not the user allows to add the address to the connected PC list.

Still further, the inter-computer information sharing system of the present invention may be characterized with including a plurality of groups of shared files corresponding, respectively, to the plurality of the connected PC lists, in which each of the plurality of groups of shared files is allowed to be provided with corresponding index.

Still further, the inter-computer information sharing system of the present invention may be characterized with including the update inquiry executing section which receives a file transmitted in response to a request by the file transmission requesting section, stores information such as the receiving time of the file and the address of the file transmitting PC, the keyword used for inquiry, the name of the file received and so forth in the reception log, and makes an inquiry regularly to the file transmitting PC of a file specified by the user about whether or not the specified file has been updated. In addition to that, the inter-computer information sharing system of the present invention may be characterized with further including the update confirming section which confirms whether or not the file is updated in response to the update inquiry and responds to the PC of making the inquiry. Still in addition to that, the inter-computer information sharing system of the present invention may be characterized with further including the file transmission requesting section which requests the transmission of the file upon reception of the response confirming that the specified file is updated.

Still further, the inter-computer information sharing system of the present invention may be characterized with including the file receiving section which receives a file transmitted as a result of a search operation in response to a search inquiry, and stores the information on the file transmitting PC as the reception log. In addition to that, the inter-computer information sharing system of the present invention may be characterized with further including the history management section which analyzes the reception log, and re-arranges PCs listed in the connected PC list according to the number of receiving files from most to least.

Still further, the inter-computer information sharing system of the present invention may be characterized with storing a received file into a directory having a group of shared files stored.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data communication apparatus connected to at least more than one of data holding apparatuses, the data communication apparatus being allowed to use at least a part of data held by the data holding apparatuses as shared data, the data communication apparatus comprising:
a search request generating and transmitting section for generating a search request which requests a data holding apparatus to search shared data corresponding to a given search condition from the shared data held by the data holding apparatus, and for transmitting the search request generated to the data holding apparatus;
a search result receiving section for receiving a search result for the search request from the data holding apparatus;
a data transmission request generating and transmitting section for generating a data transmission request which requests to transmit shared data searched based on the search result received by the search result receiving section, and for transmitting the data transmission request generated to the data holding apparatus; and
a data receiving section for receiving shared data requested to be transmitted by the data transmission request from the data holding apparatus to which the data transmission request is transmitted by the data transmission request generating and transmitting section.

2. The data communication apparatus of claim 1, wherein the search request generating and transmitting section generates the search request which requests the data holding apparatuses to search shared data which associates with a specific keyword.

3. The data communication apparatus of claim 1, wherein the search request generating and transmitting section which transmits the search request, respectively, to all the data holding apparatuses connected with the data communication apparatus.

4. The data communication apparatus of claim 1, further comprising a search request transmitting destination information storing section for storing search request transmitting destination information which specifies a certain number of the data holding apparatuses as destinations to which the search request is transmitted;
wherein the search request generating and transmitting section transmits the search request to the certain number of the data holding apparatuses specified in the search request transmitting destination information stored in the search request transmitting destination information storing section.

5. The data communication apparatus of claim 4, wherein the search request transmitting destination information storing section stores a plurality of search request transmitting destination information; and
wherein the search request generating and transmitting section transmits the search request to a certain number of data holding apparatuses specified in specific search request transmitting destination information out of the plurality of search request transmitting destination information.

6. The data communication apparatus of claim 5, wherein the search request transmitting destination information storing section stores the plurality of search request transmitting destination information each having an individual identifier being set respectively, and
wherein the search request generating and transmitting section generates the search request including an identifier being set to the specific search request transmitting destination information, and transmits the search request generated to the certain number of data holding apparatuses specified in the specific search request transmitting destination information.

7. The data communication apparatus of claim 1, wherein the search request generating and transmitting section gradually transmits the search request through a plurality of stages to a plurality of data holding apparatuses according to a given transmission order;
wherein the search result receiving section notifies the search request generating and transmitting section of stopping transmission of the search request, upon reception of a given number of search results; and
wherein the search request generating and transmitting section stops the transmission of the search request based on a notification of stopping the transmission of the search request from the search result receiving section.

8. The data communication apparatus of claim 4, wherein the search request transmitting destination information storing section stores a search request transmitting destination information including an order of transmitting the search request being set for each of the certain number of data holding apparatuses; and
wherein the data communication apparatus further comprises a transmission order setting section for transmitting test data to each of the certain number of data holding apparatuses, receiving a response to the test data from each of the certain number of data holding apparatuses, measuring a time between the transmission of the test data and the reception of the response to the test data for each of the certain number of data holding apparatuses, and for setting an order of transmitting the search request for each of the certain number of data holding apparatuses based on a measured result of each of the certain number of data holding apparatuses.

9. The data communication apparatus of claim 1, further comprising a search request history information storing section for storing search request history information which indicates for each search request a set of a search condition and corresponding search result for the search request;
wherein the search request generating and transmitting section extracts a specific search condition from the search request history information stored in the search request history information storing section, and notifies the search result receiving section of a search result corresponding to the specific search condition extracted.

10. The data communication apparatus of claim 4, further comprising an identification information communicating section for receiving from a specific data holding apparatus identification information on the specific data holding apparatus;
wherein the search request transmitting destination information storing section stores the specific data holding apparatus in the search request transmitting destination information by using the identification information of the specific data holding apparatus received by the identification information communicating section.

11. The data communication apparatus of claim 10, wherein the search request transmitting destination information storing section does not add the specific data holding apparatus in the search request transmitting destination information in a given condition.

12. The data communication apparatus of claim 10, wherein the identification information communicating section transmits identification information on the data communication apparatus to a plurality of data holding apparatuses and receives identification information from each of the plurality of data holding apparatuses;
wherein the search request transmitting destination information storing section stores the plurality of data holding apparatuses in the search request transmitting destination information by using the identification information on each of the plurality of data holding apparatuses received by the identification information communicating section.

13. The data communication apparatus of claim 1, further comprising an update confirmation requesting section for transmitting an update confirmation request which requests a specific data holding apparatus to confirm that specific shared data is updated or not;
wherein the data receiving section receives the specific shared data being updated from the specific data holding apparatus based upon a confirmation of the specific shared data being updated by the specific data holding apparatus.

14. The data communication apparatus of claim 4, wherein the search request transmitting destination information storing section stores search request transmission designation information having an order of transmitting the search request being set for each of the certain number of data holding apparatuses;
wherein the data communication apparatus further comprises a data reception number counting section for counting a number of data reception by the data receiving section for each of data holding apparatuses which transmitted shared data to the data receiving section, and for setting for each of the certain number of data holding apparatuses the order of transmitting the search request based on a counted result on the number of data reception.

15. The data communication apparatus of claim 1, further comprising:
a shared data storing section for storing data which the data communication apparatus holds as the shared data with the data holding apparatuses;
a search executing section for receiving a search request from a specific data holding apparatus, the search request requesting to search shared data corresponding to a given search condition from the shared data stored in the shared data storing section, for searching the shared data corresponding to the search condition based on the search request received, and for transmitting a search result to the specific data holding apparatus;
a data transmission request receiving section for receiving from the specific data holding apparatus a data transmission request which requests to transmit shared data searched by the search executing section; and
a data transmitting section for transmitting shared data requested to be transmitted to the specific data holding apparatus based on the data transmission request received by the data transmission request receiving section.

16. A data communication apparatus, connected with at least more than one of data holding apparatuses, sharing with the data holding apparatuses at least a part of data which the data communication apparatus holds as shared data, the data communication apparatus comprising:
a shared data storing section for storing data which the data communication apparatus holds as the shared data;
a search executing section for receiving a search request from a specific data holding apparatus, the search request requesting to search shared data corresponding to a given search condition from the shared data stored in the shared data storing section, for sharing the shared data corresponding to the search condition based on the search request received, and for transmitting a search result to the specific data holding apparatus;
a data transmission request receiving section for receiving from the specific data holding apparatus a data transmission request which requests to transmit shared data searched by the search executing section; and
a data transmitting section for transmitting shared data requested to be transmitted to the specific data holding apparatus based on the data transmission request received by the data transmission request receiving section.

17. The data communication apparatus of claim 15 or 16, further comprising an index generating section for generating an index of the shared data stored in the shared data storing section;
wherein the search executing section searches the shared data corresponding to the search condition by using the index generated by the index generating section.

18. The data communication apparatus of claim 17, wherein the index generating section generates a plurality of indexes each having an individual identifier being set; and
wherein the search executing section receives the search request including an identifier corresponding to one of identifiers being set to the plurality of indexes, and searches the shared data corresponding to the search condition by using an index having an identifier corresponding to the identifier included in the search request received.

19. The data communication apparatus of claim 17, wherein the index generating section examines regularly the shared data stored in the shared data storing section, and updates contents of the index based on an examined result.

20. The data communication apparatus of claim 15 or 16, further comprising an update confirming section for receiving from one of the data holding apparatuses an update confirmation request which requests to confirm that specific shared data is updated or not, and for confirming that the specific shared data is updated or not based on the update confirmation request received;
wherein the data transmitting section transmits the specific shared data being updated to the one of the data holding apparatuses which transmitted the update confirmation request, when the update confirming section confirms that the specific shared data has been updated.

21. The data communication apparatus of claim 15, wherein the shared data storing section stores the shared data received by the data receiving section.

22. A data communication method for communicating with at least more than one of data holding apparatuses and for using at least a part of data held by the data holding apparatuses as shared data, the data communication method comprising:
generating a search request which requests a data holding apparatus to search shared data corresponding to a given search condition from the shared data held by the data holding apparatus;
transmitting the search request generated to the data holding apparatus;
receiving search result for the search request from the data holding apparatus;
generating a data transmission request which requests to transmit shared data searched based on the search result received in the receiving the search result;
transmitting the data transmission request generated to the data holding apparatus; and
receiving shared data requested to be transmitted by the data transmission request from the data holding apparatus to which the data transmission request is transmitted in the transmitting the data transmission request.

23. A data communication method for communicating with at least more than one of data holding apparatuses and for sharing with the data holding apparatuses at least a part of data which the data communication method holds as shared data, the data communication method comprising:
storing data which the data communication method holds as the shared data;
receiving a search request from a specific data holding apparatus, the search request requesting to search shared data corresponding to a given search condition from the shared data stored in the storing;
searching the shared data corresponding to the search condition based on the search request received;
transmitting a search result to the specific data holding apparatus;
receiving a data transmission request which requests to transmit shared data searched in the searching, from the specific data holding apparatus; and
transmitting shared data requested to be transmitted to the specific data holding apparatus based on the data transmission request received in the receiving the data transmission request.
